(19) United States
(12) Patent Application Publication
(10) Pub. No.: US 2002/0137452 A1
(43) Pub. Date: Sep. 26, 2002

(54) Continuous sausage conveyor with movable casing closure mechanism

(75) Inventor: Ad J.M. Bontje, Hilversum (NL)

Correspondence Address: Zarley Law Firm, P.L.C., Capital Square, Suite 200, 400 Locust Street, Des Moines, IA, 50309-2350, US

(73) Assignee: Townsend Engineering Company, Des Moines, IA

(21) Appl. No.: 10/104,562

(22) Filed: Mar. 21, 2002

Related U.S. Application Data
(60) Provisional application No. 60/278,467, filed on Mar. 23, 2001.

(51) Int. Cl. A22C 11/02; A47J 37/08

(52) U.S. Cl. 452/46; 99/386; 99/443 C

(57) ABSTRACT

A movable casing closure apparatus is longitudinally movably-mounted on the top of a horizontal sausage conveyor and slides or rolls back and forth so that a closure element on the closure apparatus is readily available for the operator at a plurality of positions along the length of the conveyor.

### CROSS REFERENCE TO A RELATED APPLICATION

This application is based upon Applicant's Provisional Application Serial No. 60/278,467 filed Mar. 23, 2001.

### BACKGROUND OF THE INVENTION

Sausages have long been made in casings made of the intestines of animals. One of the most time-consuming steps of the process is the closing of the beginnings and endings of each casing. This closure step has been accomplished by tying or by the application of clips, or heat sealing.

However, when using a conveying system it has been cumbersome to apply closures to the sausage rope. The end that needs to be closed does not present itself to the operator in the same place each time.

Therefore a principal object of this invention is to provide a sausage conveyor with a movable closure mechanism where the closure mechanism can be moved on the conveyor to attend to the ends of a sausage strand wherever they may appear along the length of the conveyor.

### SUMMARY OF THE INVENTION

The invention consists of a closure frame mechanism mounted onto the top of a horizontal conveyor which slides back and forth so that a closure element on the frame is readily available for the operator at a plurality of positions along the length of the conveyor.

### BRIEF DESCRIPTION OF THE DRAWINGS

FIG. 1 is a side elevation of a conventional sausage conveyor with the movable closure mechanism of this invention mounted thereon;

FIG. 2 is a top plan view of FIG. 1; and

FIG. 3 is a side elevational view of an alternate form of a closure mechanism.

### DESCRIPTION OF THE PREFERRED EMBODIMENT

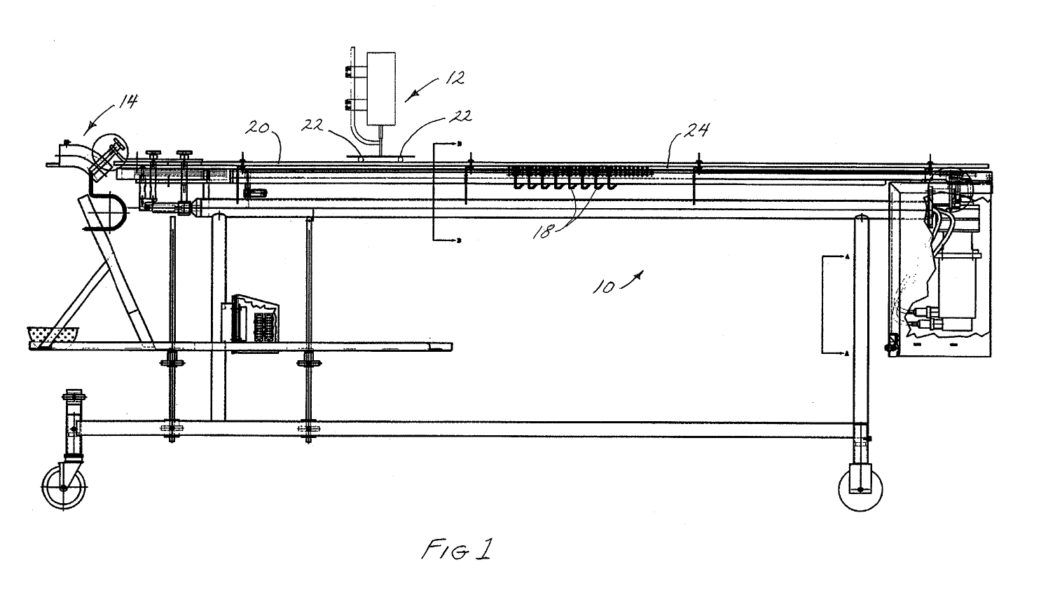

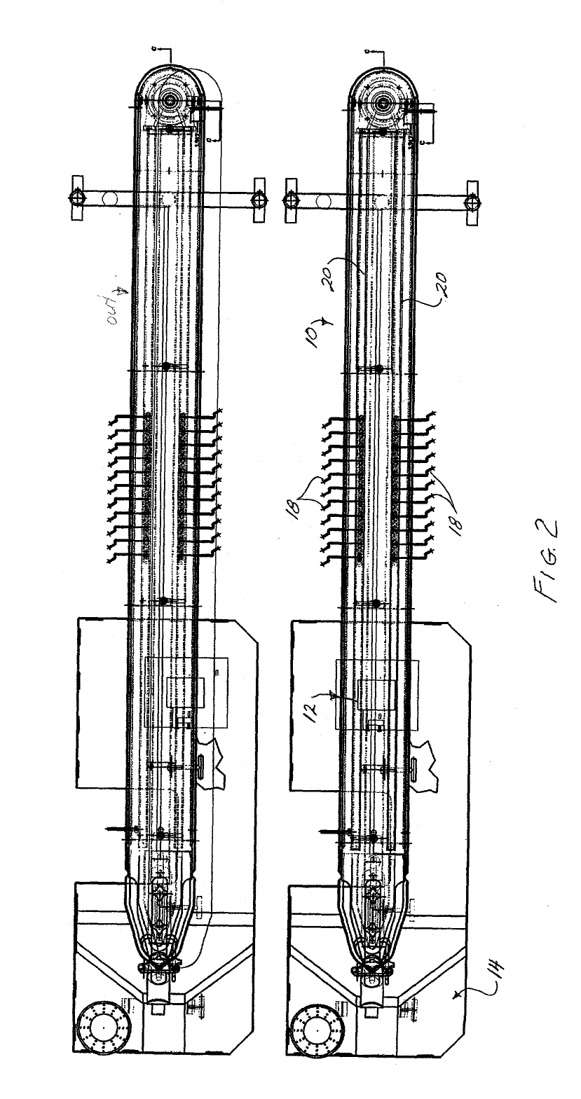

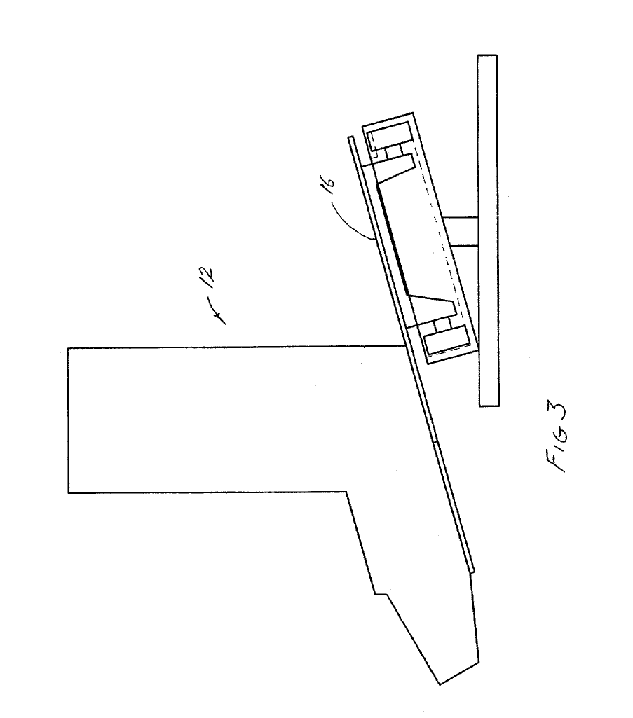

FIGS. 1 and 2 show an elongated horizontal conveyor 10, with a clipping (“closure”) apparatus 12 movably mounted on the conveyor to close ends of a sausage strand (not shown) wherever they appear along the length of the conveyor. The conveyor 10 is normally in aligned condition with a conventional sausage making machine 14. The clipping apparatus 12 shown in FIG. 3 is secured to an inclined plate 16 that locates the clipping apparatus close to the conveyor hooks 18 to bring the clipping apparatus to the close proximity to the sausage strand supported on the hooks 18. As indicated above, the clipping apparatus 12 is merely one of several conventional closure means for closing the ends of a casing. The speed at which the ends of a sausage strand can be closed is important, because this saves or minimizes the loss of sausage material from the ends of the casing. This apparatus and method are particularly useful when stuffing natural casings.

The clipping apparatus 12 is longitudinally movably mounted on parallel rails 20 mounted on top of the conveyor 10 which receive wheels 22 on the clipping apparatus.

The hooks 18 are continuously mounted around the entire length of conveyor chain 24. A linked sausage strand is deposed on the hook from machine 14. The sausage strand is suspended in loops of perhaps a dozen links carried by each hook.

The casing material into which the sausage emulsion (meat) is being extruded will vary in length from a few feet for natural casings to perhaps thirty feet for artificial casings. When the stuffing process begins, the operator will tie off or clip the forward end of the casing as the stuffing process begins. However, the operator must be very alert to quickly close the rearward end of the stuffed casing when it appears on the conveyor to prevent the meat emulsion in the casing near the rearward end from spilling out the open rearward end of the casing. When it is considered that the machine 14 may produce up to 30,000 linked sausages per hour, there are a lot of casings that need to be tied off. The tying off location is not always the same. Thus, by having the clipping apparatus mounted on wheels 22 on rails 20 on the top of conveyor 10, the operator can quickly move the apparatus 12 to the most convenient location to clip a casing closed. The sloping plate 16 is useful in that it directs the operative part of the clipping apparatus more closely to the loops of linked sausages hanging on the hooks. This facilitates the clipping operation that takes place at the level of, or below the hooks 18. The clipping apparatus is preferably pneumatically operated by a source of compressed air (not shown).

It is therefore seen that this invention will achieve at least all of its stated objectives.

What is claimed is:

1. A sausage conveyor, comprising,
an elevated elongated horizontal frame,
a continuous sausage hook chain disposed in a horizontal plane on the frame,
a plurality of sausage hooks on the chain,
a sausage closure apparatus longitudinally movably mounted on the frame and adapted to be moved longitudinally to service the ends of a sausage strand supported by the hooks at selected positions along the length of the frame,
and power means connected to the chain for rotating the same in a horizontal plane.

2. The conveyor of claim 1 wherein the closure apparatus is mounted on an inclined plate that extends towards the hooks to locate a closure element on the closure apparatus in close proximity of a sausage strand supported on the hooks.

3. A method of closing the ends of a sausage strand suspending on the hook of a horizontal conveyor mounted on a horizontally disposed conveyor frame, comprising,
mounting a sausage closure apparatus for longitudinal movement adjacent a length of sausage strand bearing hooks on a conveyor so that when an open end of a sausage strand appears on the hooks, the closure apparatus can be quickly moved to the position of the open end to close the same.
